(19) United States
(12) Patent Application Publication
(10) Pub. No.: US 2011/0283940 A1
(43) Pub. Date: Nov. 24, 2011

(54) Wafer Processing Device and Coating Device

(76) Inventors: Chih-Saing Jhong, Hualien County (TW); Sheng Cheng, Taipei County (TW)

(21) Appl. No.: 12/852,523

(22) Filed: Aug. 9, 2010

(30) Foreign Application Priority Data
May 18, 2010 (TW) 099115794

(51) Int. Cl. B05C 13/02

(52) U.S. Cl. 118/668

(57) ABSTRACT

A wafer processing device includes a wafer pedestal, a plurality of lift pins retractably installed in the wafer pedestal for supporting a wafer, and a plurality of sensing devices. The sensing devices are correspondingly coupling to the plurality of supporting pins for sensing a weight or a center of gravity of the wafer. Moreover, a coating device is provided.

### BACKGROUND OF THE INVENTION

1. Field of the Invention

The present invention relates to a wafer processing device, more particular, to a wafer processing device and a coating device that are able to measure the weight and center of gravity of a wafer.

2. Description of the Prior Art

In semiconductor manufacturing processes, a semiconductor wafer must go through many coating processes from start to finish, such as lithographic resist and developer coating processes. With the narrowing line width in semiconductor processes, photolithographic technology has become critical, because all the MOS components, metallic wires, thin film patterns and dopant regions should be made by the photolithographic process. Moreover, the pattern-transferring process, mandatory in photolithography, is complicated and subtle, and so only a precise pattern of resist can ensure the reliability of later processes.

In general, a coating device typically includes a wafer pedestal and a nozzle. A wafer is placed stably on a support surface of the wafer pedestal. The nozzle is used to spread a photoresist onto the wafer. Ideally, when the wafer is attached on the supporting surface by vacuum and is driven to rotate, the photoresist is uniformly coated on the wafer by the centrifugal force, making the surface of the wafer covered by the photoresist layer with uniform thickness and no defects. But in actual operation environment, the photoresist coating quality is usually affected by the position of the wafer on the supporting surface, or the position of the nozzle relative to that of the wafer center.

In preferred situation, the photoresist should be spread upon the center of the wafer such that it can be coated evenly on the wafer after rotating. However, in practice, the placing position of the wafer may offset, or the position of the nozzle which is used over time may shift, affecting the location of the photoresist spread onto the wafer. If the location of the photoresist spread onto the wafer is deviated from the center of the wafer, after the spin coating process, the problem of uneven photoresist coating will occur.

Besides, when insufficient photoresist is provided onto the wafer, it will also lead to coating defects. Nevertheless, current coating devices lack a sensing mechanism which is able to detect the position of the wafer and the distribution of the photoresist on the wafer in real time to prevent the problems of uneven photoresist coating and the coating defects. In conventional arts, it is usually after the development of the photoresist that the defects can be detected and reproducing or rework process can be decided. However, the procedures of forming the defective wafers and then reproducing the wafers not only affect the wafer yield but also increase the production cost.

### SUMMARY OF THE INVENTION

The present invention provides a wafer processing device for sensing the weight and the center of gravity of the wafer in real time during processing.

The present invention provides a coating device for sensing the weight and the center of gravity of the wafer in real time to prevent the problem of uneven wafer coating or wafer coating defects.

The present invention provides a wafer processing device including a wafer pedestal, a plurality of lift pins and a plurality of sensing devices. The wafer pedestal is used for holding a wafer. The lift pins are retractably installed in the wafer pedestal for supporting the wafer. The sensing devices are correspondingly coupling to the plurality of supporting pins for sensing a weight of the wafer.

In one embodiment of the present invention, the wafer processing device further includes a cap member encapsulating a tip of each of the lift pins and contacting the wafer. The sensing devices are disposed within the cap members.

In one embodiment of the present invention, the sensing devices are used to measure a center of gravity of the wafer, or an offset of the center of gravity relative to a predetermined center of gravity. The sensing device includes a piezoelectric material or a piezoelectric sensor.

The present invention further provides a coating device including a wafer pedestal, a nozzle, a plurality of lift pins and a plurality of sensing devices. The wafer pedestal is used for holding a wafer. The nozzle is used for spreading the photoresist onto the wafer. The lift pins are retractably installed in the wafer pedestal to support the wafer. The sensing devices are correspondingly coupling to the lift pins for sensing a weight of the wafer and/or the photoresist.

In one embodiment of the present invention, the nozzle or the lift pins is made of stainless steel. In addition, the coating device further includes a cap member encapsulating a tip of each of the lift pins and contacting the wafer. The sensing devices are disposed within the cap members.

In one embodiment of the present invention, the sensing devices include a piezoelectric material or a piezoelectric sensor. In addition, the sensing devices are used to measure a center of gravity of the wafer, or an offset of the center of gravity relative to a predetermined center of gravity. The coating device further includes a computer connecting to the sensing devices for calculating and storing the predetermined center of gravity. Moreover, the coating device further includes an alarm device that can provide an alarm signal when the offset exceeds a predetermined value.

Based on the above description, the present invention provides a coating device that is able to detect the weight and center of gravity of the wafer and the photoresist in real time according to the difference of the weight or the offset of the center of gravity when the wafer is held or the photoresist is spread on the wafer so as to prevent the problems of uneven photoresist coating or coating defects, which is caused by insufficient photoresist coating or incorrect position of photoresist spreading in conventional arts.

Moreover, the present invention further provides a wafer processing device. By detecting the weight and gravity of center in real time, the problem of wafer defects or position offsets can be prevented.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of the coating device before the photoresist is spread thereon according to one preferred embodiment in the present invention

FIG. 2 illustrates a schematic diagram of the coating device after the photoresist is spread thereon.

FIG. 3 illustrates a flow chart of one preferred embodiment of the photoresist coating process.

FIG. 4 illiterates a schematic diagram of one preferred embodiment of the wafer processing device.

### DETAILED DESCRIPTION

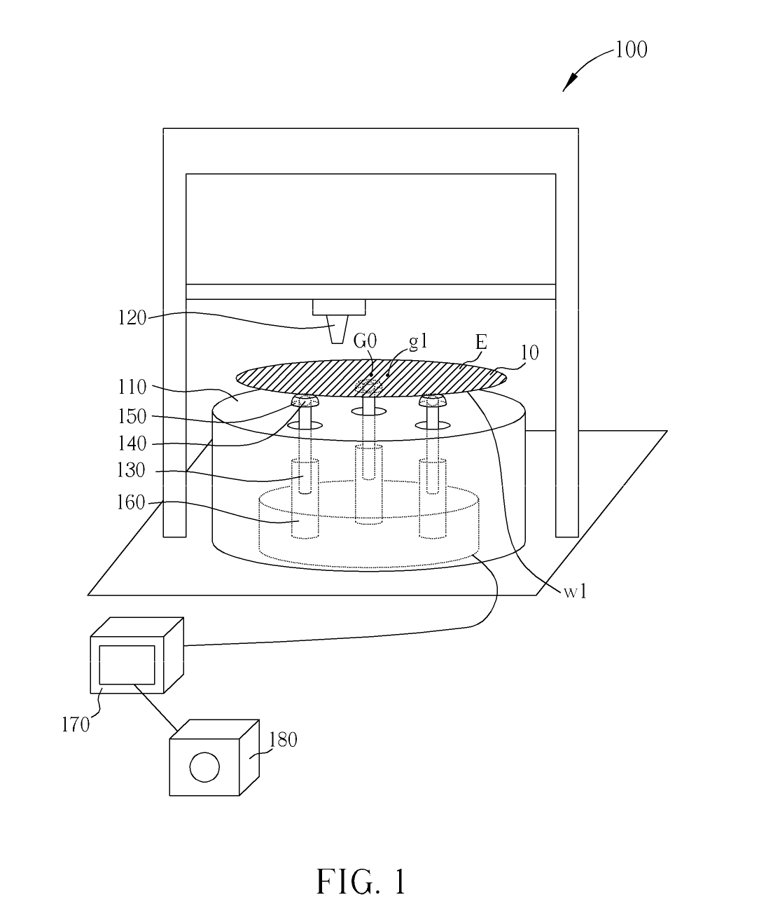

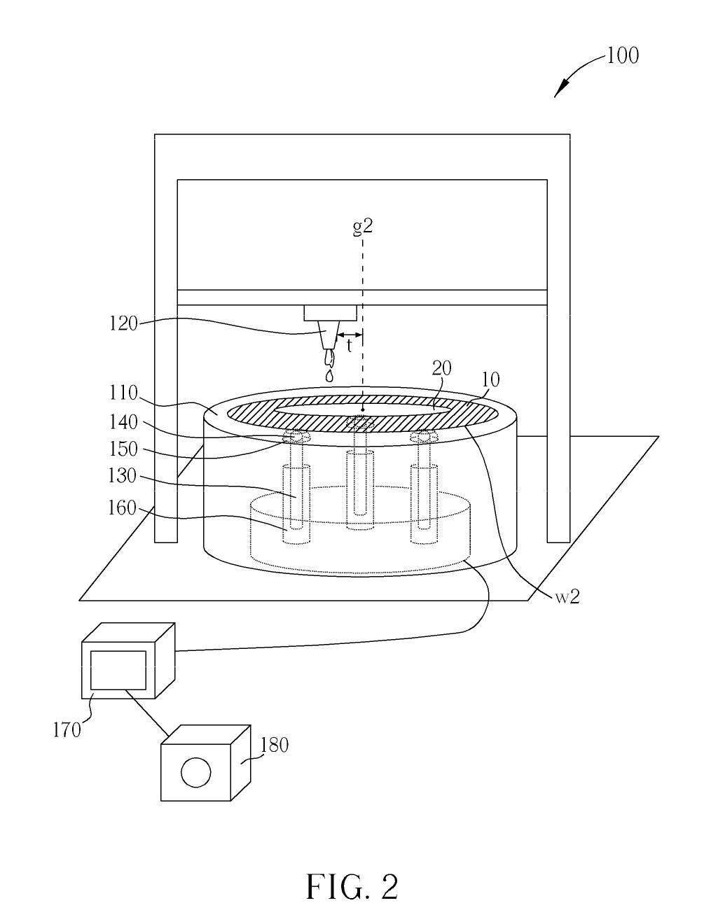

FIG. 1 illustrates a schematic diagram of the coating device before the photoresist is spread thereon according to one preferred embodiment in the present invention. FIG. 2 illustrates a schematic diagram of the coating device after the photoresist is spread thereon. As shown in FIG. 1 and FIG. 2, the coating device 100 includes a wafer pedestal 110, a nozzle 120, a plurality of lift pins 130 and a plurality of sensing devices 140. The wafer pedestal 110 is used for holding a wafer 10. The nozzle 120 is used for spreading the photoresist 20 onto the wafer 10. The lift pins 130 are retractably installed in the wafer pedestal no. The sensing devices 140 are correspondingly coupling to the plurality of lift pins 130 for sensing a weight of the wafer 10 and/or the photoresist 20. According to the present structure, the lift pins 130 can stretch out from the wafer pedestal no to contact and support the wafer 10. The sensing devices 140 which are correspondingly coupling to the lift pins 130 can measure the weight of the wafer 10. When the lift pins 130 retract back into the wafer pedestal 110 and do not contact the wafer 10, the wafer pedestal no can drive the wafer 10 to rotate and the coating process is therefore performed. The supporting surface of the wafer pedestal no usually includes a plurality of slots (not shown) for tightly attaching the wafer 10 by vacuum, wherein the shape of the slots is not limited.

In detail, as shown in FIG. 1, when the lift pins 130 are stretching out from the wafer pedestal no, the wafer 10 is transferred by a robot arm (not shown) to the lift pins 130. As the lift pins 130 contacts the wafer 10, the total weight w1 of the wafer 10 can be obtained by summing up the weight applied on each contacting point between the lift pins 130 and the wafer 10 by the sensing device 140. At this time, the center of gravity g1 of the wafer 10 can be calculated by a computer 170 as well. Moreover, as shown in FIG. 2, before the lift pins 130 retract into the wafer pedestal no, the lift pins 130 still contact the wafer 10. When the photoresist 20 is spread onto the wafer 10 by the nozzle 120, the total weight w2 of the wafer 10 plus the photoresist 20 can be obtained by summing up the weight applied on each contacting point of the lift pins 130 and the wafer 10 by the sensing device 140. In the meanwhile, the center of gravity g2 of the wafer 10 plus the photoresist 20 can also be calculated by the computer 170. In other words, when only the wafer 10 is placed on the lift pins 130, the sensing device 140 can detect the total weight w1 of the wafer 10; similarly, when the wafer 10 and the photoresist 20 are placed on the lift pins 130, the sensing device 140 can detect the total weight w2 of the wafer 10 plus the photoresist 20. That is, the weight of the photoresist 20 can be obtained by reducing the weight w1 of the wafer 10 from the weight w2 of the wafer 10 plus the photoresist 20. Accordingly, by installing the sensing device 140, the supply adequacy of the photoresist 20 which is spread onto the wafer 10 by the nozzle 120 can be checked so as to prevent the coating defects caused by insufficient photoresist supply and further prevent the remaking process after producing a defect wafer, thereby decreasing the costs of discarding these defect wafers.

Specifically, according to the weight of each point detected by the sensing devices 140, besides the weight w1 of the wafer 10 and the weight w2 of the wafer 10 plus the photoresist 20, the center of gravity g1 of the wafer 10 and the center of gravity g2 of the wafer 10 plus the photoresist 20 can also be calculated and measured by the sensing device 140. In ideal situation, the wafer 10 should be placed in a predetermined position such that the photoresist 20 spread by the nozzle 120 can fall on a center of the top surface E of the wafer 10 and being coated evenly after the wafer 10 is rotated by the wafer pedestal no. Moreover, for a wafer 10 with uniform thickness and quality, its center of gravity should be coincident with its center of shape. Accordingly, the center of shape of the wafer 10 and the center of shape of the wafer 10 plus the photoresist 20 can be calculated by detecting the center of gravity g1 of the wafer 10 or the center of gravity g2 of the wafer 10 plus the photoresist 20. However, in actual operation, the position of the nozzle 120 relative to the wafer 10 may shift when the wafer 10 is transferred by the robot arm (not shown), or when the nozzle 120 is used after a period of time, thus affecting the location of the photoresist 20 spread onto the wafer 10. In this situation, the present invention provides a method to solve the location-shifting problem of the wafer 10 by detecting the center of gravity g1 and a predetermined center of gravity (corresponding to a predetermined position) and then comparing these two positions. Once the center of gravity is changed, a control unit (not shown), for example, can control the robot arm (not shown) to carry out the position calibration process in real time for the wafer 10 or the nozzle 120. Similarly, for the problem of nozzle 120 shifting, when the photoresist 20 is spread onto the wafer 10, the center of gravity g1 of the wafer 10 should change in ideal situation because the center of gravity g2 of the wafer 10 plus the photoresist 20 should be located at the same position as the center of gravity g1 of the wafer. However, when the position of the nozzle 120 is shifted, the shifting can be measured by comparing the position of the center of gravity g2 and the center of the gravity g1, and the position of the wafer 10 or the position of the nozzle 120 can be adjusted to make the center of gravity g1 coincide with the center of gravity g2 so as to achieve uniform coating of the photoresist 20 on the wafer 10.

Specifically, the nozzle 120 and the lift pins 130 can be made of stainless steel. The coating device 100 further includes a cap member 150 encapsulating a tip of each of lift pins 130 and contacting the wafer 10. In one preferred embodiment of the present invention, the sensing device 140 is disposed within the cap member 150. The material of the cap member 150 includes silicon or other wear-resistive or etching-resistive materials. Besides, the sensing device 140 includes piezoelectric material or piezoelectric sensor. When the sensing device 140 receives a gravity signal, a corresponding current is generated in the sensing device 140 to detect the gravity applied on the sensing device 140. It is understood that the sensing device 140 is not limited to be disposed in the cap member 150. In another embodiment, the sensing device 140 can be disposed in other places as long as it can detect the weight of the wafer 10.

Moreover, for instance, the coating device 100 can be LITHIUS Pro or LITHIUS produced by Tokyo Electron Limited. The LITHIUS can proceed a coating process for one wafer 10 at a time while the LITHIUS Pro can proceed a coating process for three wafers at a time. Thus the LITHIUS Pro has a more coating efficiency. In another embodiment, the coating device 100 can be other types of coating devices. However, due to the increased distance for the nozzle 120 or the robot arm (not shown) to transfer the wafer 10, the position for placing the wafer 10 is more easily to shift, increasing the possibility of wafer defects. Accordingly, as the industry emphasizes to enhance the manufacturing efficiency and lower the costs, the real time detecting mechanism provided by the present invention is much more important.

The coating device 100 may further includes a computer 170 connected to the sensing device 140 in order to compute the center of gravity of the wafer 10 and store the information of the predetermined center of gravity G0. In one embodiment, the coating device 100 further includes an alarm device 180 to provide an alarm signal when the offset value exceeds a predetermined value, thereby warning the user of those improper coating problems. In another embodiment, the coating device 100 further includes a display panel (not shown) which shows the coating state in real time for the user during the coating process.

In the present embodiment, the nozzle 120 is held stationary during the coating step while the position of the wafer 10 is movable so as to change the relative position between the nozzle 120 and the wafer 10. However, in another embodiment not shown, the nozzle 120 is movable. That is, the moving speed of the nozzle 120 can be altered according to the rotation speed of the wafer 10 so as to provide a more uniform coating of the photoresist 20. In the present embodiment, three lift spins 130 are used. However, in another embodiment, more than three lift pins 130 can be used as well, and should not be limited thereto.

In detail, the coating device 100 further includes a hollow tube 160 encapsulating each of the lift pins 130, making the lift pins 130 able to move upwardly and downwardly relative to the wafer pedestal 110 within a mobile space, so as to sense the weight of the wafer 10 or make the wafer 10 rotatable on the wafer pedestal no. Besides, the sensing device 140 in the present embodiment is disposed on a top portion of each lift pin 130 and is disposed within the cap member 150. In another embodiment, the sensing device 140 such as a piezoelectric material can be disposed between the lift pins 130 and the hollow tubes 160 where the lift pins 130 can be fixed by the piezoelectric material or being movable upwardly or downwardly. In still another embodiment, the sensing device 140 can be disposed under the lift pins 130 and connected to the lift pins 130 by a stick structure to drive the lift pins 130 move upwardly and downwardly.

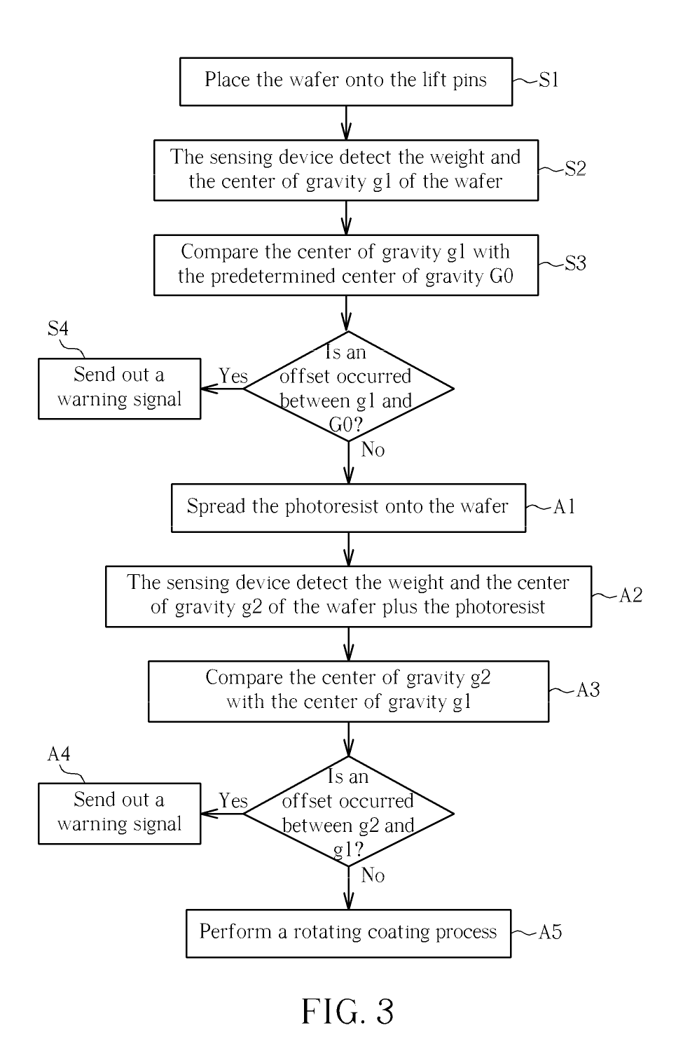

In general, the sensing method of the coating device 100 includes the following steps (as shown in FIG. 3). First, a wafer 10 is placed onto the lift pins 130 by a robot arm (not shown). At this point, the lift pins 130 are stretching upwardly from the wafer pedestal no and holding the wafer 10 (step S1). The weight of the wafer 10 triggers the sensing device 140 (for example, a piezoelectric sensor) to generate a corresponding current, which is then transmitted to the computer 107. The weight of the wafer 10 on each contacting point is calculated. Subsequently, the weight w1 of the wafer 10 and the center of gravity g1 are calculated by the sensing device 140 according to the weight on each contacting point (step S2). Next, the center of gravity g1 is compared with the predetermined center of gravity G0 (step S3). If an offset is occurred between the center of gravity g1 and the predetermined center of gravity G0, an alarm device 180 such as a voice alarm device is used to send out a warning signal (step S4) to inform the user to re-adjust the wafer 10 or the nozzle 120. On the contrary, if the center of gravity g1 is coincided with the predetermined center of gravity G0, meaning the wafer 10 is placed at the correct location, the photoresist coating process can be continued.

The subsequent steps are shown below. First, the photoresist 20 is spread onto the wafer 10 by the nozzle 120 (step A1). The weight of the photoresist 120 therefore changes the corresponding current generated by the sensing device 140, and the weight W2 of the photoresist 20 plus the wafer 10 is detected by the sensing device 140. It is understood that the weight of the photoresist 20 can be obtained by reducing the weight w2 from the weight w1. Adequate amount of photoresist 20 is therefore checked to make the photoresist 20 coated uniformly on the wafer 10. Besides, according to the weight on each contacting point, the center of gravity g2 of the wafer 10 plus the photoresist 20 can be calculated by the sensing device 140 (step A2). Meanwhile, the center of gravity g2 is compared with the center of gravity g1. If an offset is occurred between the center of gravity g1 and the center of gravity g2, then an alarm device 180 such as a voice alarm device (not shown) is used to send out an alarm signal to inform the user (step A4). On the contrary, if the center of gravity g1 is coincided with the center of gravity g2, meaning weight center of the wafer 10 plus the photoresist 20 is located in the same position as the weight center of the wafer 10, then a spin rotating step can be carried out to coat the wafer 20 onto the wafer 10 by a centrifugal force (step A5).

In another embodiment not explicitly shown in the figures, the weight or the center of gravity of the wafer 10 and the photoresist 20 can be re-checked after the coating process to ensure the uniform of coating, but should not be limited thereto.

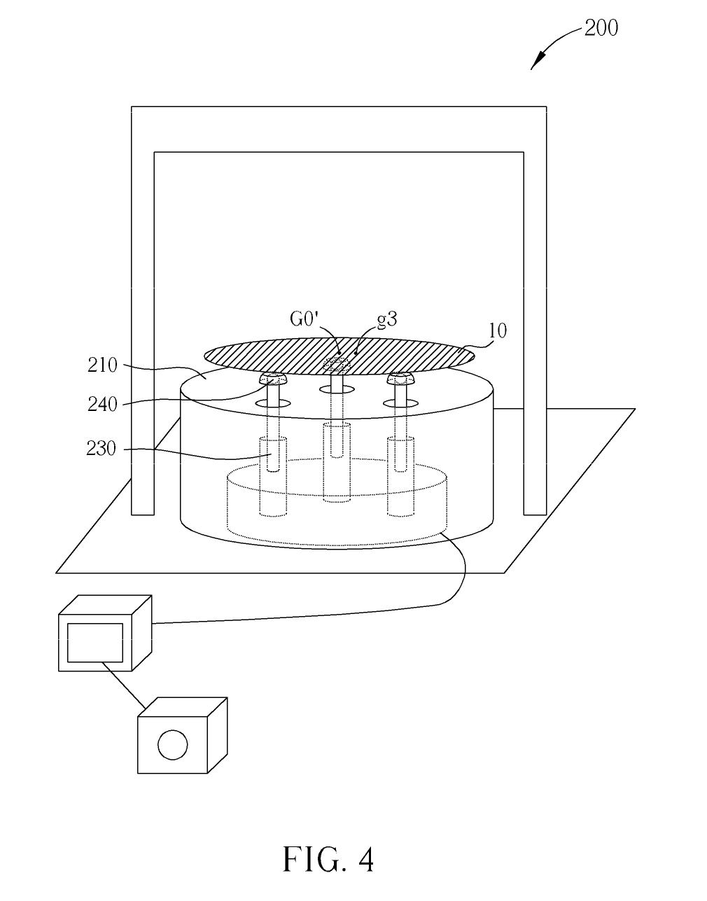

Moreover, even though the aspect of the present embodiment is used in the coating device 100, it may also be used in other devices that need monitoring the weight or center of gravity of the wafer in real time, such as a sputtering device, but should not be limited thereto. For example, as shown in FIG. 4, a wafer processing device 200 includes a wafer pedestal 210, a plurality of lift pins 230 and a plurality of sensing devices 240. The wafer pedestal 210 is used for holding a wafer 10. The lift pins 230 are retractably installed in the wafer pedestal 210 and are able to stretch out to support the wafer 10. The sensing devices 240 are correspondingly coupling to the lift pins 230 for sensing a weight of the wafer 10. The detail description of each components and their operation mechanism are similar to those of the coating device 100 described above and are not repeated for the sake of simplicity. By detecting the weight or center of the gravity g3 of the wafer 10 and comparing the offset between the center of gravity g3 relatively to the predetermined center of gravity, the wafer 10 can be ensured to be disposed at the correct location.

In light of above, the present invention provides a coating device that is able to detect the weight and center of gravity of the wafer and the photoresist in real time when the wafer is held or when the photoresist is spread onto the wafer according to the difference of the weight or the offset of the center of gravity so as to monitor the spreading state of the photoresist. Accordingly, the problem of uneven coating or coating defects of the wafer caused by insufficient photoresist coating or incorrect position of photoresist spreading can be alleviated by the present invention just before rotating the wafer or coating the photoresist.

Moreover, the present invention further provides a wafer processing device applicable to devices other than coating devices, where the wafer processing device includes similar components and operation mechanism to the coating device. By detecting the weight and gravity of center in real time, the problem of wafer defects or position offsets can be prevented.

Those skilled in the art will readily observe that numerous modifications and alterations of the device and method may be made while retaining the teachings of the invention.

What is claimed is:

1. A wafer processing device, comprising:
a wafer pedestal for holding a wafer;
a plurality of lift pins retractably installed in said wafer pedestal; and
a plurality of sensing devices correspondingly coupling to said plurality of lift pins for sensing a weight of said wafer.

2. The wafer processing device according to claim 1 further comprising a cap member encapsulating a tip of each of said plurality of lift pins.

3. The wafer processing device according to claim 1 wherein said sensing device comprises a piezoelectric material or a piezoelectric sensor.

4. The wafer processing device according to claim 1 wherein said sensing device is used to measure a center of gravity of said wafer.

5. The wafer processing device according to claim 4 wherein said sensing device is used to measure an offset of said center of gravity relative to a predetermined center of gravity.

6. A coating device, comprising:
a wafer pedestal for holding a wafer;
a nozzle for spreading photoresist onto said wafer;
a plurality of lift pins retractably installed in said wafer pedestal; and
a plurality of sensing device correspondingly coupling to said plurality of lift pins for sensing a weight of said wafer and/or said photoresist.

7. The coating device according to claim 6 further comprising a cap member encapsulating a tip of each of said plurality of lift pins.

8. The coating device according to claim 6 wherein said sensing device is used to measure a center of gravity of said wafer.

9. The coating device according to claim 6 wherein said sensing device is used to measure an offset of said center of gravity relative to a predetermined center of gravity.

10. The coating device according to claim 9 further comprising a computer connecting to an alarm device, wherein said computer is used to calculate and store said predetermined center of gravity, and an alarm of said alarm device is activated when said offset exceeds a predetermined value.
